(19) United States
(12) Patent Application Publication
(10) Pub. No.: US 2024/0086710 A1
(43) Pub. Date: Mar. 14, 2024

(54) COMPUTER-READABLE RECORDING MEDIUM STORING MACHINE LEARNING PROGRAM, DEVICE, AND METHOD

(71) Applicant: FUJITSU LIMITED, Kawasaki-shi (JP)

(72) Inventors: Hiroaki KINGETSU, Kawasaki (JP); Kenichi KOBAYASHI, Kawasaki (JP)

(73) Assignee: FUJITSU LIMITED, Kawasaki-shi (JP)

(21) Appl. No.: 18/515,043

(22) Filed: Nov. 20, 2023

Related U.S. Application Data
(63) Continuation of application No. PCT/JP2021/019817, filed on May 25, 2021.

(51) Int. Cl. G06N 3/082

(52) U.S. Cl. CPC G06N 3/082

(57) ABSTRACT

A recording medium stores a machine learning program causing a computer to execute a processing of: generating a first parameter relating to a first pruning process that generates a first machine learning model to classify a first class in classes by executing the first pruning process on a machine learning model which classifies into the classes based on a parameter of the machine learning model and training data including the first class which serves a correct answer label; and generating a second parameter relating to a second pruning process that generates a second machine learning model to classify a second class in the classes by executing the second pruning process on the machine learning model based on the parameter of the machine learning model, training data including the second class which serves the correct answer label and a loss function including the first parameter relating to the first pruning process.

### CROSS-REFERENCE TO RELATED APPLICATION

This application is a continuation application of International Application PCT/JP2021/019817 filed on May 25, 2021 and designated the U.S., the entire contents of which are incorporated herein by reference.

### FIELD

The disclosed technology relates to a machine learning program, a machine learning device, and a machine learning method.

### BACKGROUND

For machine learning models that classify into a plurality of classes, there is a technique for generating a machine learning model for classifying a specific plurality of classes by generating a plurality of individual machine learning models that classify only a part of classes by pruning and by combining the plurality of individual machine learning models. For example, a technique for cutting out a subnetwork from a neural network that has been machine learned by using a super mask has been proposed. In this technique, forward processing of machine learning is executed by preparing a score matrix corresponding to a weight of an edge of the neural network and applying a super mask in which the upper k % element of the score matrix is set to 1 and other elements are set to 0 to the weight of the neural network. In this technique, at the time of backward processing, the weight of the edge of the neural network is fixed, and machine learning is executed by a gradient method for each score of the score matrix.

Related art is disclosed in Non-patent literature: Vivek Ramanujan, Mitchell Wortsman, Aniruddha Kembhavi, Ali Farhadi, and Mohammad Rastegari, “What's Hidden in a Randomly Weighted Neural Network?”, CVPR, 31 Mar. 2020.

### SUMMARY

According to an aspect of the embodiments, a non-transitory computer-readable recording medium stores a machine learning program causing a computer to execute a processing of: generating a first parameter relating to a first pruning process that generates a first machine learning model to classify a first class in a plurality of classes by executing the first pruning process on a machine learning model which classifies into the plurality of classes based on a parameter of the machine learning model and training data including the first class which serves a correct answer label; and generating a second parameter relating to a second pruning process that generates a second machine learning model to classify a second class in the plurality of classes by executing the second pruning process on the machine learning model based on the parameter of the machine learning model, training data including the second class which serves the correct answer label and a loss function including the first parameter relating to the first pruning process.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram of a machine learning device.

FIG. 2 is a diagram of an example of an N class classifier.

FIG. 3 is a diagram for explaining modularization of the N class classifier.

FIG. 4 is a diagram for explaining modularization of the N class classifier.

FIG. 5 is a diagram for explaining generation of a base mask.

FIG. 6 is a diagram for explaining generation of a mask other than the base mask.

FIG. 7 is a functional block diagram of a classification device.

FIG. 8 is a diagram for explaining an example of processing by the machine learning device and the classification device.

FIG. 9 is a block diagram illustrating a schematic configuration of a computer functioning as the machine learning device.

FIG. 10 is a block diagram illustrating a schematic configuration of a computer functioning as the classification device.

FIG. 11 is a flowchart illustrating an example of machine learning processing.

FIG. 12 is a flowchart illustrating an example of classification processing.

FIG. 13 is a diagram for explaining an example of experimental results of a sharing ratio of parameters among modules in the present embodiment.

### DESCRIPTION OF EMBODIMENTS

As described above, by selecting and combining individual machine learning models corresponding to tasks at the time of operation among the individual machine learning models generated by pruning, there is an effect that a number of parameters of the machine learning model may be reduced compared with the original machine learning model. However, depending on a structure of the individual machine learning models, the effect of pruning may be reduced in the machine learning model generated by the combination.

As one aspect, in the disclosed technique, when a machine learning model is generated by combining the individual machine learning models that classify only a part of classes generated by pruning from the original machine learning model by pruning, the effect of pruning is suppressed from being reduced.

Hereinafter, an example of an embodiment according to the disclosed technology will be described with reference to the drawings. A machine learning system according to the present embodiment includes a machine learning device and a classification device. The machine learning device generates a mask for modularizing a N class classifier. A classifier generates a specific class classifier according to a task using the generated mask and classifies operation data. Hereinafter, each of the machine learning device and the classification device will be described in detail.

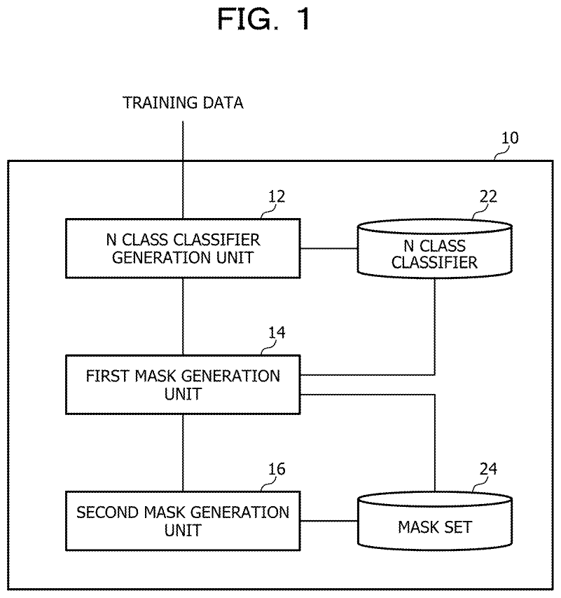

First, the machine learning device will be described. As illustrated in FIG. 1, a machine learning device 10 functionally includes an N class classifier generation unit 12, a first mask generation unit 14, and a second mask generation unit 16. Further, an N class classifier 22 and a mask set 24 are stored in a predetermined storage area of the machine learning device 10.

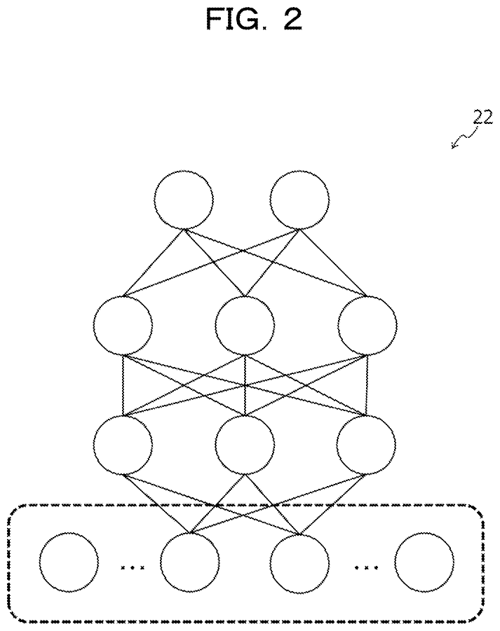

The N class classifier generation unit 12 generates an N class classifier 22 which is a classifier for classifying input data into any of N classes. For example, the N class classifier 22 may be a Neural Network (NN) as illustrated in FIG. 2. In the example of FIG. 2, circles represent individual neurons, and the neurons in each layer are coupled by edges. An output layer (broken line portion in FIG. 2) has N neurons corresponding to each class, and each neuron of the output layer outputs a probability that the input data is classified into each class.

The N class classifier generation unit 12 acquires training data input to the machine learning device 10, and calculates an edge weight as a parameter of the N class classifier 22 by machine learning using the acquired training data. The training data is data in which data such as image data, audio data, and sensor data is associated with a correct label indicating the class to which the data belongs.

In this embodiment, a partial network that may classify only a part of classes is extracted as a module from the N class classifier 22 as described above, and the modules are appropriately combined with each other to generate a classifier that may classify an arbitrary multi-class. The advantages of modularization are that risk verification becomes easier as the network becomes smaller, and that a number of parameters of the classifier generated by combining the modules with each other may be reduced. Since an amount of calculation is reduced as the number of parameters of the classifier is small, practicability as a classifier used at the time of operation is enhanced.

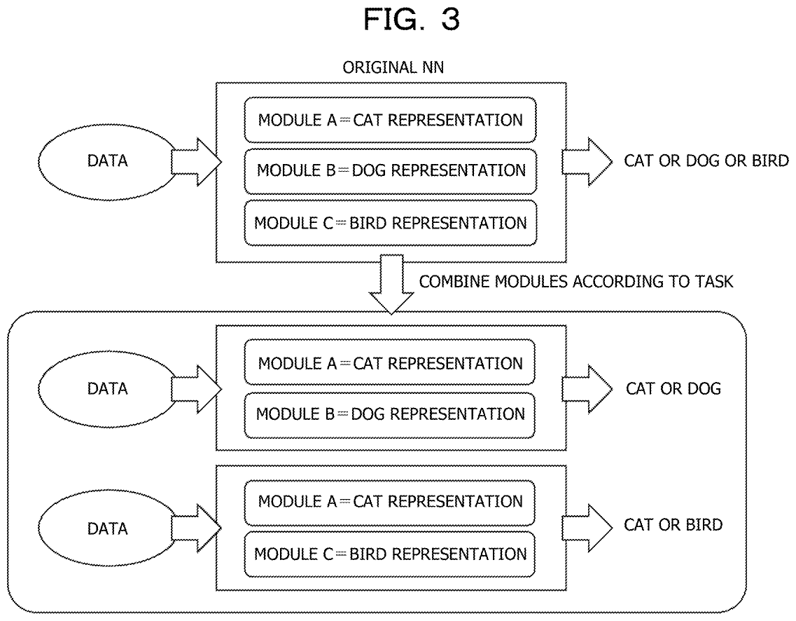

Here, the modularization of the neural network will be described. For example, as illustrated in an upper part in FIG. 3, it is assumed that an original neural network classifies the input data into any of three classes of “cat”, “dog” and “bird”. The original neural network includes a partial network representing the class “cat”, a partial network representing the class “dog”, and a partial network representing the class “bird”. The machine learning device extracts the partial network representing the class “cat” as a module A, the partial network representing the class “dog” as a module B, and the partial network representing the class “bird” as a module C. Then, as illustrated in a lower part in FIG. 3, when the task at the time of operation is a task for classifying whether the input data indicates the cat or the dog, the machine learning device generates a classifier in which the modules A and B are combined. The machine learning device classifies the input data into the class “cat” or the class “dog” using the classifier in which the module A and the module B are combined. Similarly, when the task at the time of operation is a task for classifying whether the input data indicates the cat or the bird, the machine learning device 10 generates a classifier in which the modules A and C are combined and classifies the input data into the class “cat” or the class “bird”.

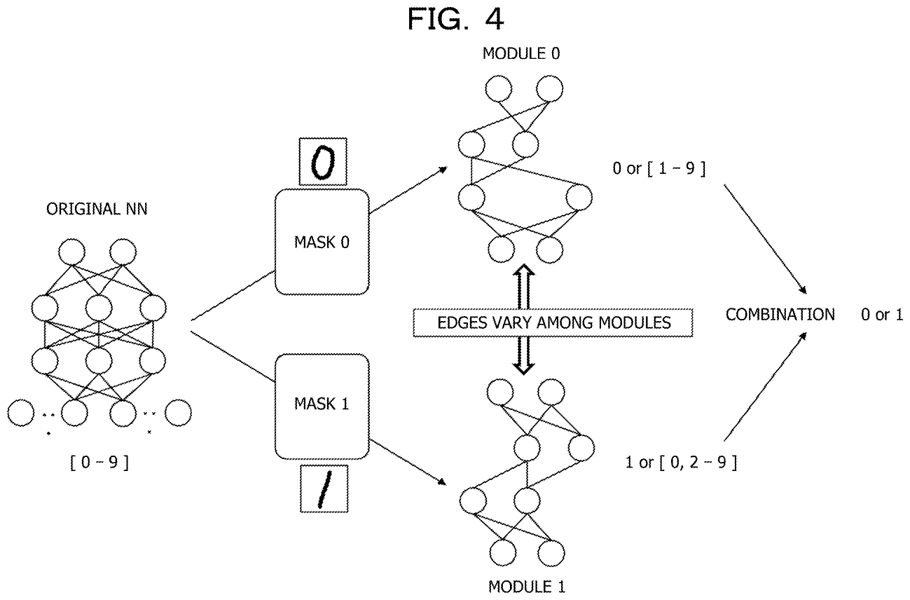

As a technique for modularizing the neural network (NN), as described in the above-mentioned Non-patent literature, there is a technique of applying a super mask. The modularization by this method will be explained by taking as an example a case where the original neural network (NN) is a neural network (NN) of 10 class classifications corresponding to 10 numbers of Modified National Institute of Standards and Technology database (MNIST) which is an image data set of handwritten numbers. As illustrated in FIG. 4, when the original neural network (NN) is pruned by the “mask 0” generated by machine learning based on the training data of the correct answer label “0”, the remaining partial network becomes the module 0. The module 0 is a single class classifier that classifies whether the number indicated by the input image data is “0” or other numbers (1 to 9). Similarly, when the original neural network (NN) is pruned by the “mask 1” generated by machine learning based on the training data of the correct answer label “1”, the remaining partial network becomes the module 1. The module 1 is a single class classifier that classifies whether the number indicated by the input image data is “1” or other numbers (0, 2 to 9). By combining the modules 1 and 2, a classifier of a two class classification that classifies “0” or “1” is generated.

As described above, the fact that the number of parameters of the classifier generated by combining modules may be reduced is an effect of the modularization by pruning the original neural network. However, there may be variations in the edges included in the modules among the generated modules. In such a case, since there are few edges shared among modules, for example, the ratio in which the same parameters are shared among modules is low, the effect of the modularization by the above-mentioned pruning becomes weak. For example, when the number of edges included in the original neural network (NN) is large, variations of pruning becomes large, so that the variations of the edges included in the modules becomes large among the modules generated by pruning. Therefore, in the present embodiment, each module is generated so as to suppress the variations of the edges among the modules. Hereinafter, the first mask generation unit 14 and the second mask generation unit 16 for generating a mask for generating a module will be described in detail.

A first mask generation unit 14 generates parameters relating to a first pruning process based on parameters of a machine learning model which classifies into a plurality of classes and training data in which a first class of the plurality of classes is included in the correct answer label. The parameters relating to the first pruning process is a parameter for generating a first machine learning model for classifying the first class by executing the first pruning process on the machine learning model.

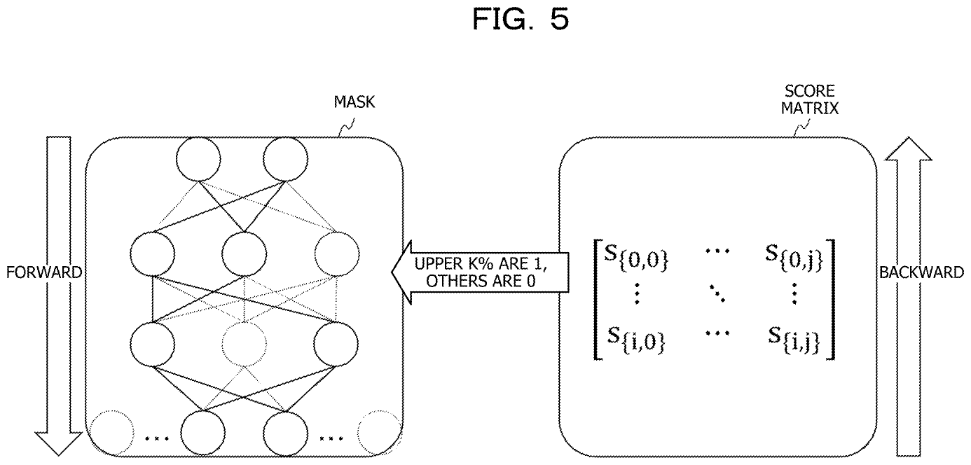

For example, as illustrated in FIG. 5, the first mask generation unit 14 prepares a score matrix having scores corresponding to respective edges of the original neural network (NN) serving as elements. In the right figure of FIG. 5, s_{{I,j}} is a score corresponding to the j-th edge of the i-th layer of the original neural network (NN). An initial value of the score matrix may be set at random. The first mask generation unit 14 generates a mask in which the upper k % elements in the score matrix in the descending order of the score are set to 1 and the other elements in the score matrix are set to 0. In addition, the first mask generation unit 14 may generate a mask in which an element whose score is equal to or greater than a predetermined value is set as 1 and an element whose score is less than the predetermined value is set as 0, in the score matrix. A first mask generation unit 14 executes forward processing of machine learning by using a partial network including an edge corresponding to an element having a generated mask value of 1 and neurons coupled by the edge in the original neural network (NN). In the left figure of FIG. 5, a portion of the original neural network corresponding to an element having a mask value of 1 is represented by a solid line, and a portion of the original neural network corresponding to an element having a mask value of 0 is represented by a dotted line. For example, the first mask generation unit 14 inputs training data to the portion of the original neural network corresponding to the mask value of 1 and propagates the training data in the forward direction. At this time, the first mask generation unit 14 sets the correct answer label y of the training data to a value indicating a positive example for a specific class and a value indicating a negative example for other classes. The “specific class” is one of a plurality of classes classified by the original neural network (NN), and may be any of the plurality of classes. Then, the first mask generation unit 14 obtains the classification result y\hat{ } (“\hat{ } (hat)” on “y” in the mathematical expression described later).

The first mask generation unit 14 performs backward processing of machine learning on each score of the score matrix, not on the weight of the edge of the neural network (NN). For example, the first mask generation unit 14 updates each score of the score matrix by a error back propagation method so that the classification result y A approaches the correct answer label y. For example, the first mask generation unit 14 updates each score of the score matrix so as to minimize the loss function represented by the following equation (1).

[Formula 1]

L=CE(y,ŷ) (1)

CE (y, y\hat{ }) is the cross entropy between y and y\hat{ }. The first mask generation unit 14 repeats the forward processing and the backward processing until the end determination of the machine learning is satisfied. Accordingly, in the score matrix, among the edges included in the original neural network, a score corresponding to an edge with a high degree of appropriateness to be left as an edge of a module for classifying the specific class becomes a larger value. The first mask generation unit 14 uses a mask generated from a score matrix at the end of machine learning as a mask for generating a module for classifying the specific class. Hereinafter, the mask generated by the first mask generating unit 14 is referred to as a “base mask”, and the module generated by the base mask is referred to as a “base module”. The first mask generation unit 14 adds the generated base mask to the mask set 24 and stores the base mask, and delivers a score matrix corresponding to the base mask to the second mask generation unit 16.

A second mask generation unit 16 generates a parameter relating to a second pruning process based on a parameter of a machine learning model, training data in which a second class of a plurality of classes is included in a correct answer label, and a loss function including a parameter relating to a first pruning process. The parameter relating to the second pruning processing is a parameter for generating a second machine learning model for classifying the second class by executing the second pruning processing on the machine learning model for classifying the plurality of classes.

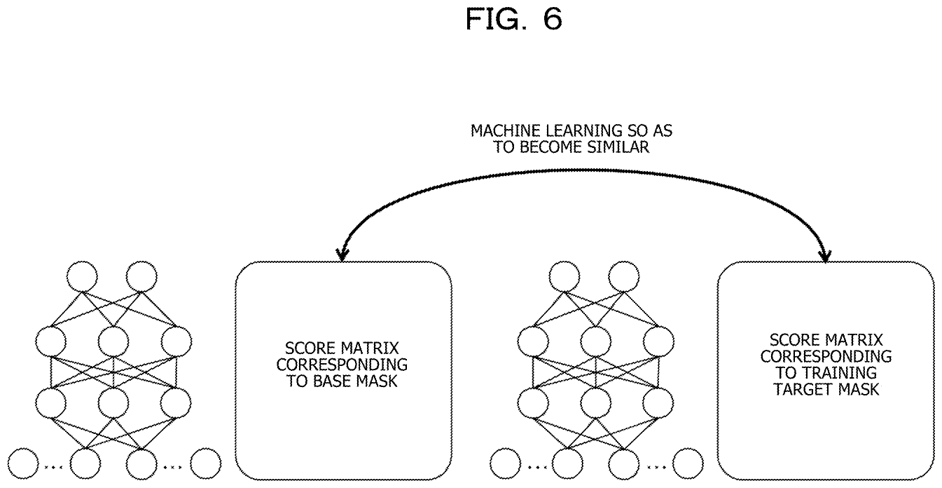

For example, the second mask generation unit 16 generates a mask for generating a module for classifying each class by machine learning based on training data associated with each correct answer label indicating a class other than the specific class, similarly to the first mask generation unit 14. In the following description, the mask generated by the second mask generation unit 16 is referred to as a “training target mask” and the module generated by the training target mask is referred to as a “training target module”. At the time of this machine learning, the second mask generation unit 16 updates each score of the score matrix corresponding to the training target mask so that the score matrix corresponding to the training target mask becomes similar to the score matrix corresponding to the base mask, as illustrated in FIG. 6. For example, the second mask generation unit 16 updates each score of the score matrix for each training target mask so as to minimize the loss function L as represented by the following equation (2).

$$\begin{matrix}[ Formula 2 ] & \\ L = CE ( y , \hat{y} ) + λ {\sum }_{i} {\sum }_{j} \vert {s}_{\{ i , j \}} - {s}_{\{ i , j \}}^{*} \vert & ( 2 )\end{matrix}$$

s_{{I,j}} is a value of each element of the score matrix corresponding to the training target mask, s_{{I,j}}* is a value of each element of the score matrix corresponding to the base mask, and A is a hyperparameter. For example, the loss function illustrated in Formula (2) is obtained by adding a regularization term in which the difference of the score matrix between modules is set as a penalty to the loss function illustrated in Formula (1). As a result, the training target mask for executing a pruning process similar to the base module is generated, and the training target module similar to the base module may be generated. The second mask generation unit 16 adds the generated training target mask to the mask set 24 and stores the generated training target mask.

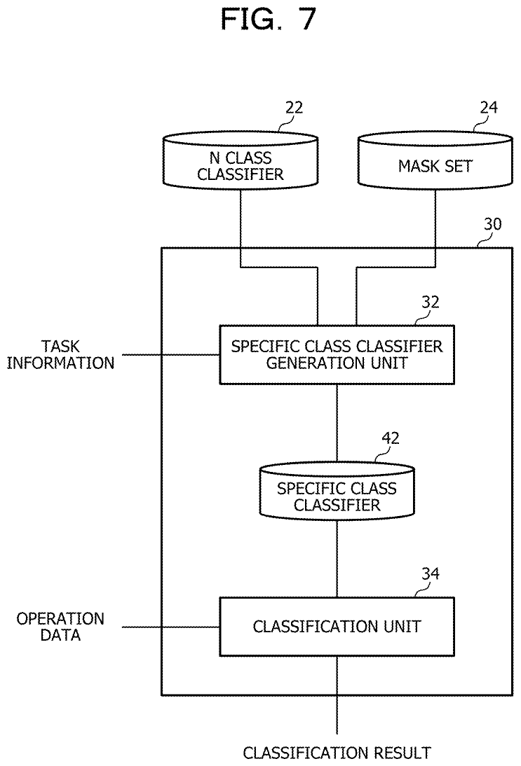

Next, the classification device will be described. As illustrated in FIG. 7, the classification device 30 functionally includes a specific class classifier generation unit 32 and a classification unit 34. A specific class classifier 42 is stored in a predetermined storage area of the classification device 30.

The specific class classifier generation unit 32 receives task information relating to a task at the time of operation. The task information includes information specifying a module corresponding to the task. The specific class classifier generation unit 32 acquires a mask corresponding to the specified module from the mask set 24 based on the received task information. The specific class classifier generation unit 32 also acquires the original neural network (NN) that is the N class classifier 22. The specific class classifier generation unit 32 extracts a union of portions corresponding to each of the masks acquired from the mask set 24 (hereinafter referred to as “union portion”) from the acquired original neural network (NN). By applying the acquired mask to the union portion, a module corresponding to the mask is generated. The specific class classifier generation unit 32 stores the extracted union portion and the acquired mask as the specific class classifier 42.

The classification unit 34 acquires the operation data, inputs the operation data into the specific class classifier 42, and outputs the class to which the operation data belongs among the classes corresponding to the tasks as the classification result. The operation data is the same as training data except that the correct answer label is unknown. For example, the classification unit 34 applies each of the masks included in the specific class classifier 42 to the union portion to generate each of the modules for classifying each of the classes corresponding to the task. The classification unit 34 inputs the operation data to each module to obtain classification results, integrates each of the classification results, and determines a final classification result. The classification unit 34 may determine the classification result output from each module, for example, the classification result output from the module indicating the highest probability among the probabilities in which the operation data belongs to the class corresponding to each module, as the final classification result. The classification unit 34 outputs the determined final classification result.

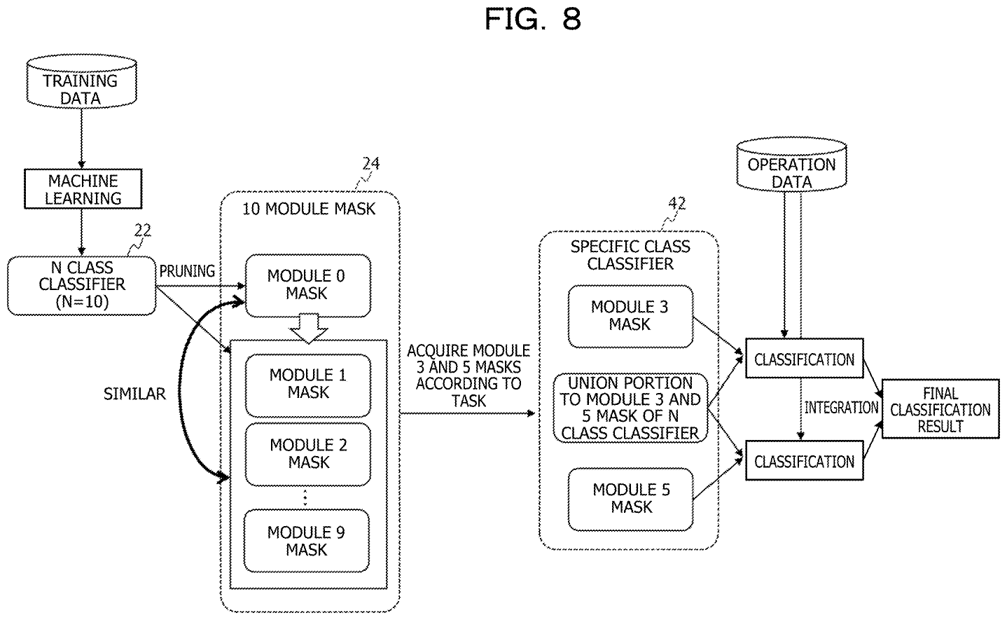

Here, with reference to FIG. 8, an example of processing by the machine learning device 10 and the classification device 30 will be described by taking as an example a task of modularizing NNs of the 10 class classifications corresponding to 10 numbers which are 0 to 9 of the MNIST and classifying the operation data into class “3” or class “5”.

First, the N class classifier generation unit 12 generates an N (N=10) class classifier 22 by machine learning using the training data. The first mask generation unit 14 generates a base mask by machine learning based on the training data associated with the correct answer label indicating one class and the N class classifier 22. FIG. 8 illustrates an example in which, based on the training data associated with the correct answer label “0”, a module 0 mask for generating a module 0 which is a single class classifier for classifying whether a number indicated by the input image data is 0 or not 0 is set as the base mask. The second mask generation unit 16+ generates each of the module 1 mask to the module 9 mask for generating the modules 1 to 9, respectively. At this time, the second mask generation unit 16 generates each of the module 1 mask to the module 9 mask so that each of the score matrices corresponding to each of the module 1 mask to the module 9 mask become similar to the score matrix corresponding to the base mask. As a result, ten masks corresponding to each of the modules 0 to 9 are generated and stored as the mask set 24.

The specific class classifier generation unit 32 receives the task information specifying the modules 3 and 5, and acquires the module 3 mask and the module 5 mask from the mask set 24. The specific class classifier generation unit 32 extracts a union portion of a portion corresponding to the module 3 mask and a portion corresponding to the module 5 mask from among the N class classifiers 22, and stores the union portion as the specific class classifier 42 together with the module 3 mask and the module 5 mask. The specific class classifier generation unit 32 generates the module 3 by applying the module 3 mask to the union portion and generates the module 5 by applying the module 5 mask to the union portion. The classification unit 34 acquires image data of handwritten numbers as the operation data and inputs the operation data into the module 3, thereby obtaining a classification result indicating the probability in which the number indicated by the operation data is 3. Similarly, the classification unit 34 obtains a classification result indicating the probability in which the number indicated by the operation data is 5 by inputting the operation data into the module 5. The classification unit 34 outputs a classification result having a higher probability as a final classification result. For example, when the classification result of the module 3 is 90% and the classification result of the module 5 is 10%, the classification unit 34 outputs a classification result indicating that the number indicated by the operation data is “3”.

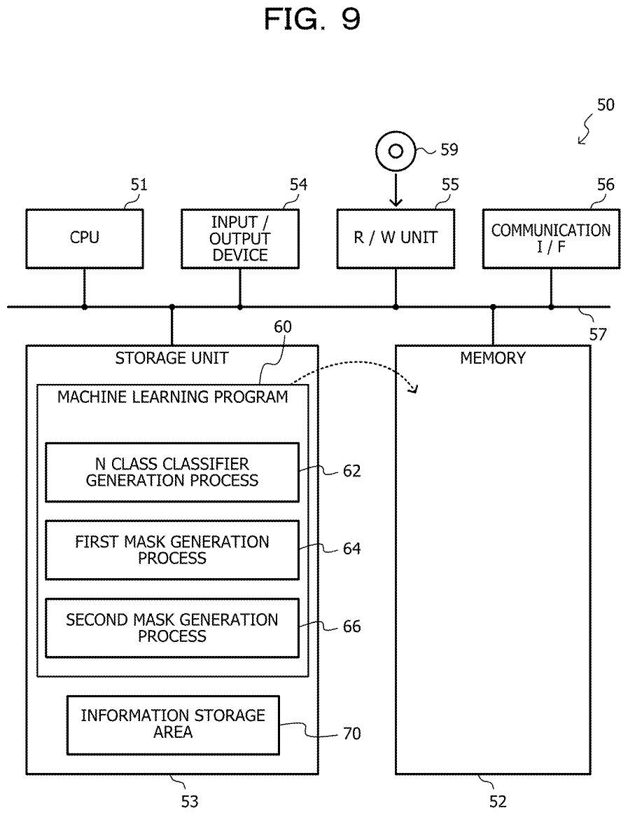

The machine learning device 10 may be implemented by, for example, a computer 50 illustrated in FIG. 9. The computer 50 includes a central processing unit (CPU) 51, a memory 52 as a temporary storage area, and a storage unit 53 of non-volatile. The computer 50 also includes an input/output device 54 such as an input unit and a display unit, and an R/W (Read/Write) unit 55 for controlling reading and writing of data from and to a storage medium 59. The computer 50 also includes a communication interface (I/F) 56 coupled to a network such as the Internet. The CPU 51, the memory 52, the storage unit 53, the input/output device 54, the R/W unit 55, and the communication I/F 56 are coupled to each other via a bus 57.

The storage unit 53 may be implemented by a hard disk drive (HDD), a solid state drive (SSD), a flash memory, or the like. A machine learning program 60 for causing the computer 50 to function as the machine learning device 10 is stored in the storage unit 53 as a storage medium. The machine learning program 60 includes an N class classifier generation process 62, a first mask generation process 64, and a second mask generation process 66. The storage unit 53 also has an information storage area 70 in which information constituting each of the N class classifier 22 and the mask set 24 is stored.

The CPU 51 reads the machine learning program 60 from the storage unit 53, develops the machine learning program 60 in the memory 52, and sequentially executes processes of the machine learning program 60. The CPU 51 operates as the N class classifier generation unit 12 illustrated in FIG. 1 by executing the N class classifier generation process 62. The CPU 51 executes the first mask generation process 64 to operate as the first mask generation unit 14 illustrated in FIG. 1. Further, the CPU 51 operates as the second mask generation unit 16 illustrated in FIG. 1 by executing the second mask generation process 66. Further, the CPU 51 reads information from the information storage area 70 and develops each of the N class classifier 22 and the mask set 24 in the memory 52. As a result, the computer 50 executing the machine learning program 60 functions as the machine learning device 10. The CPU 51 for executing the program is a hardware.

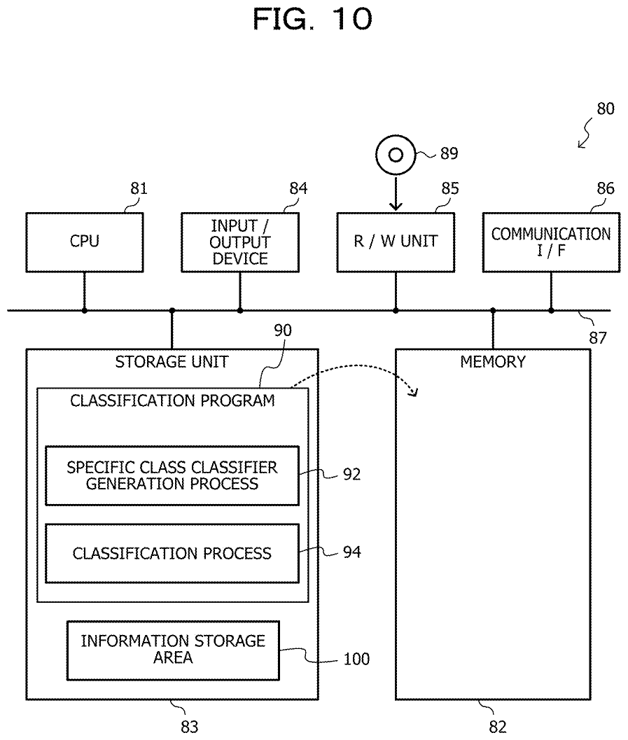

The classification device 30 may be implemented by a computer 80 illustrated in FIG. 10, for example. The computer 80 includes a CPU 81, a memory 82 as a temporary storage area, and a storage unit 83 of non-volatile. The computer 80 also includes an input/output device 84 such as an input unit and a display unit, an R/W unit 85 for controlling reading and writing of data from and to a storage medium 89, and a communication I/F 86. The CPU 81, the memory 82, the storage unit 83, the input/output device 84, the R/W unit 85, and the communication I/F 86 are coupled to each other via a bus 87.

The storage unit 83 may be realized by an HDD, an SSD, a flash memory or the like. A classification program 90 for causing the computer 80 to function as the classification device 30 is stored in the storage unit 83 as a storage medium. The classification program 90 includes a specific class classifier generation process 92 and a classification process 94. The storage unit 83 also has an information storage area 100 in which information constituting the specific class classifier 42 is stored.

The CPU 81 reads the classification program 90 from the storage unit 83 and develops the classification program 90 in the memory 82 to sequentially execute processes of the classification program 90. The CPU 81 executes the specific class classifier generation process 92 to operate as the specific class classifier generation unit 32 illustrated in FIG. 7. The CPU 81 executes the classification process 94 to operate as the classification unit 34 illustrated in FIG. 7. The CPU 81 also reads information from the information storage area 100 and develops the specific class classifier 42 in the memory 82. As a result, the computer 80 executing the classification program 90 functions as the classification device 30. The CPU 81 for executing the program is a hardware.

The functions realized by each of the machine learning program 60 and the classification program 90 may also be realized by a semiconductor integrated circuit, for example, an Application Specific Integrated Circuit (ASIC) or the like.

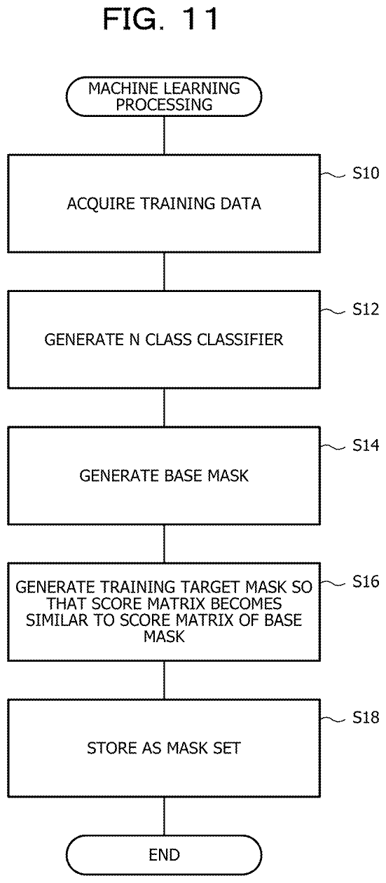

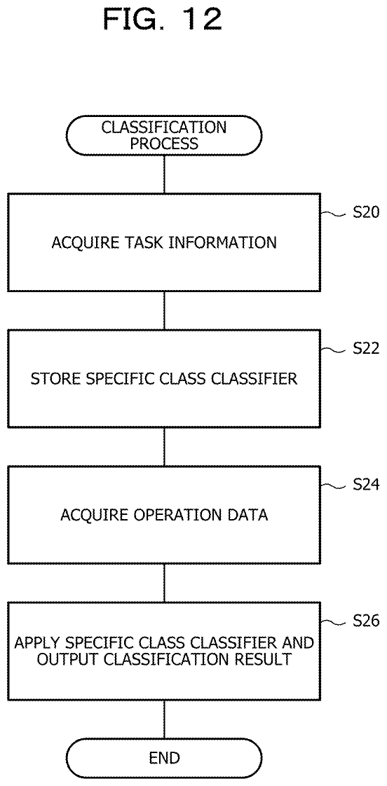

Next, the operation of the machine learning system according to the present embodiment will be described. When the training data is input to the machine learning device 10 and generation of a mask for modularization is instructed, the machine learning process illustrated in FIG. 11 is executed in the machine learning device 10. When the task information and the operation data are input to the classification device 30 and an instruction is given to classify the operation data, the classification process illustrated in FIG. 12 is executed in the classification device 30. Hereinafter, each of the machine learning process and the classification process will be described. The machine learning process and the classification process are examples of the machine learning method of the disclosed technology.

First, the machine learning processing will be described with reference to FIG. 11.

In step S10, the N class classifier generation unit 12 acquires the training data input to the machine learning device 10. Next, in step S12, the N class classifier generation unit 12 generates the N class classifier 22 by machine learning using the acquired training data.

Next, in step S14, the first mask generation unit 14 prepares a score matrix having scores corresponding to respective edges of the N class classifier 22 as elements. It is assumed that the correct answer label y of the training data acquired by the first mask generation unit 14 is set as a positive example for the specific class and a negative example for other classes. Then, the first mask generation unit 14 inputs the training data and propagates the training data in the forward direction for a portion of the score matrix where a mask in which the upper k % elements in the descending order of scores are set to 1 and the other elements are set to 0 is applied to the N class classifier 22 to obtain the classification result y A. Further, the first mask generation unit 14 updates each score of the score matrix by the error back propagation method so that the classification result y A approaches the correct answer label y, and generates the base mask from the score matrix at the end of the machine learning.

Next, in step S16, similarly to step S14 described above, the second mask generating unit 16 generates the training target masks for generating the training target modules for classifying classes other than the specific class. At this time, the second mask generation unit 16 generates each of the training target masks so that the score matrix becomes similar to the score matrix of the base mask. Next, in step S18, each of the first mask generation unit 14 and the second mask generation unit 16 stores the generated masks as the mask set 24, and the machine learning process is terminated.

Next, the classification process will be described with reference to FIG. 12.

In step S20, the specific class classifier generation unit 32 acquires the task information including information specifying a module corresponding to the task. Next, in step S22, the specific class classifier generation unit 32 acquires a mask corresponding to the module specified by the task information from the mask set 24. In addition, the specific class classifier generation unit 32 extracts a union portion of a portion corresponding to each of the acquired masks from the N class classifier 22, and stores the union portion as the specific class classifier 42 together with the acquired mask.

Next, in step S24, the classification unit 34 acquires the operation data input to the classification device 30. Next, in step S26, the classification unit 34 applies each of the masks included in the specific class classifier 42 to the union portion to generate each of the modules for classifying each of the classes according to the task. Then, the classification unit 34 inputs the operation data into each module to obtain the classification results, integrates each of the classification results, determines the final classification result, and outputs the final classification result. Then, the classification process is terminated.

As described above, according to the machine learning system according to the present embodiment, the machine learning device generates the base mask used for pruning processing for generating the base module based on the N class classifier and the training data including the first class of the N class in the correct answer label. The base mask is generated by binarizing the score matrix having scores corresponding to each edge of the N class classifier as elements. In addition, the machine learning device generates the mask used for pruning processing for generating other modules based on the N class classifier, the training data including the second class of the N classes in the correct answer label, and the loss function including values of the score matrix corresponding to the base mask. By applying the mask thus generated to the N class classifier to generate each module, the ratio of sharing the same parameters among modules is increased. Accordingly, it is possible to suppress a reduction of the effect of pruning that reduces the number of parameters of a classifier generated by combining modules.

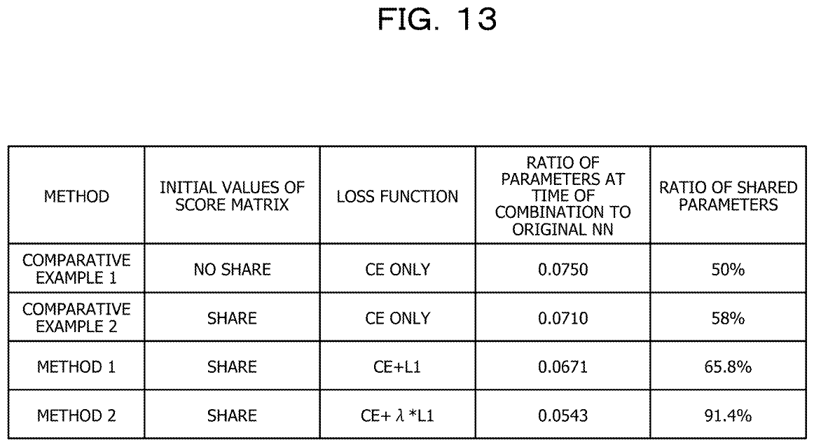

With reference to FIG. 13, an example of experimental results of the sharing ratio of parameters among modules in the present embodiment will be described. In this experiment, similar to the MNIST example described in FIG. 8, ten modules for classifying each class from 0 to 9 have been generated from the 10 class classifier (original neural network (NN)). Each module has been generated by performing a pruning process so that the number of parameters (weight of each edge) is 5% of the original neural network (NN). Comparative Examples 1 and 2 illustrated in FIG. 13 are methods that do not include a regularization term in which the difference of the score matrix between modules is set as a penalty in the loss function used at the time of updating the score matrix for mask generation. Comparative Example 1 is a case where the initial values of the score matrix are not shared among the modules, and Comparative Example 2 is a case where the initial values of the score matrix are shared among the modules. In addition, Method 1 and Method 2 include a regularization term in which the difference of the score matrix between modules is set as a penalty in the loss function as in the above embodiment. In Method 1, the hyperparameter A for the regularization term is set to λ=1, and in Method 2, the hyperparameter A for the regularization term is set to λ=10. In both Method 1 and Method 2, the initial values of the score matrix are shared among modules.

In FIG. 13, “ratio of the number of parameters at the time of combination to the original neural network (NN)” is the ratio of the number of parameters when two modules are combined to the number of parameters of the original neural network (NN). Also, this value is an average of 45 pairs of all combinations of two modules out of ten (10) modules. As described above, since each module is generated so that the number of parameters is 5% of that of the original neural network (NN), this value is 0.05 to 0.1, which indicates that the smaller this value, the more similar the two modules are. In FIG. 13, the “ratio of shared parameters” is a ratio of the number of parameters shared by two modules to be combined.

As described above, when the modules are similar to each other, there is an effect that the number of parameters of a model when modules are combined may be reduced. In order to obtain this effect, it is considerable to share the initial value of the score matrix between modules, unlike this method. However, as illustrated in FIG. 13, in comparison between Comparative Example 1 and Comparative Example 2, by sharing the initial value of the score matrix among modules, the ratio of shared parameters is slightly improved. On the other hand, in Method 1 and Method 2, the ratio of shared parameters is greatly improved. For example, Method 1 and Method 2 are more effective in reducing the number of data in the model than Comparative Examples 1 and 2. In addition, when the influence of the regularization term included in the loss function is made larger as in Method 2, the effect becomes more remarkable.

In the above embodiment, although an example of modularization in units of one class has been described, the present embodiment is not limited to this. For example, it is sufficient to modularize a partial network that may classify a part of a plurality of classes capable of being classified by the original machine learning model such as generating a module for classifying two classes or a module for classifying three classes from a 10 class classifier.

Although a case where the machine learning device and the classification device are respectively implemented by separate computers has been described in the above embodiment, the machine learning device and the classification device may be implemented by a single computer.

In the above-described embodiment, a case where the machine learning program and the classification program are stored (installed) in advance in the storage unit has been described. However, the program relating to the disclosed technology may also be provided in a form stored in a storage medium such as a Compact Disk Read Only Memory (CD-ROM), a Digital Versatile Disk Read Only Memory (DVD-ROM), a Universal Serial Bus (USB) memory, or the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program causing a computer to execute a processing of:
generating a first parameter relating to a first pruning process that generates a first machine learning model to classify a first class in a plurality of classes by executing the first pruning process on a machine learning model which classifies into the plurality of classes based on a parameter of the machine learning model and training data including the first class which serves a correct answer label; and
generating a second parameter relating to a second pruning process that generates a second machine learning model to classify a second class in the plurality of classes by executing the second pruning process on the machine learning model based on the parameter of the machine learning model, training data including the second class which serves the correct answer label and a loss function including the first parameter relating to the first pruning process.

2. The non-transitory computer-readable recording medium according to claim 1, wherein the generating the second parameter includes:
minimizing the loss function including a first term which represents a difference between a classification result of the second class by the second machine learning model and the correct answer label, and a second term which represents a difference between the first parameter and the second parameter.

3. The non-transitory computer-readable recording medium according to claim 1, wherein
the machine learning model is a neural network, and
the first parameter corresponds to each of edges included in the machine learning model and is a score which increases as a first degree of appropriateness to be left as an edge of the first machine learning model for the respective edges becomes higher, and
the second parameter corresponds to each of the edges included in the machine learning model and is a score which increases as a second degree of appropriateness to be left as an edge of the second machine learning model for the respective edges becomes higher.

4. The non-transitory computer-readable recording medium according to claim 1, wherein the processing further comprising:
generating first masks indicating that first edges, among the edges, included in an upper predetermined percentage in descending order of the corresponding first parameter or second edges, among the edges, having the corresponding first parameter greater than a predetermined value are left in the first machine learning model;
generating second masks indicating that third edges, among the edges, included in the upper predetermined percentage in descending order of the corresponding second parameter or fourth edges, among the edges, having the corresponding second parameter greater than the predetermined value are left in the second machine learning model.

5. The non-transitory computer-readable recording medium according to claim 4, wherein the processing further comprising:
selecting one or more masks from the first masks and the second masks;
applying each of the one or more masks on a portion of the machine learning model corresponding to a union of the one or more masks; and
generating a third machine learning model that classifies classes corresponding to the one or more masks.

6. The non-transitory computer-readable recording medium according to claim 5, wherein the processing further comprising:
inputting data whose class to be classified is unknown to the third machine learning model; and
classifying the data into classes corresponding to the one or more masks.

7. An information processing device comprising:
a memory; and
a processor coupled to the memory and configured to:
generate a first parameter relating to a first pruning process that generates a first machine learning model to classify a first class in a plurality of classes by executing the first pruning process on a machine learning model which classifies into the plurality of classes based on a parameter of the machine learning model and training data including the first class which serves a correct answer label; and
generate a second parameter relating to a second pruning process that generates a second machine learning model to classify a second class in the plurality of classes by executing the second pruning process on the machine learning model based on the parameter of the machine learning model, training data including the second class which serves the correct answer label and a loss function including the first parameter relating to the first pruning process.

8. The information processing device according to claim 7, wherein a processing to generate the second parameter includes:
minimizing the loss function including a first term which represents a difference between a classification result of the second class by the second machine learning model and the correct answer label, and a second term which represents a difference between the first parameter and the second parameter.

9. The information processing device according to claim 7, wherein
the machine learning model is a neural network, and
the first parameter corresponds to each of edges included in the machine learning model and is a score which increases as a first degree of appropriateness to be left as an edge of the first machine learning model for the respective edges becomes higher, and
the second parameter corresponds to each of the edges included in the machine learning model and is a score which increases as a second degree of appropriateness to be left as an edge of the second machine learning model for the respective edges becomes higher.

10. The information processing device according to claim 7, wherein the processor:
generates first masks indicating that first edges, among the edges, included in an upper predetermined percentage in descending order of the corresponding first parameter or second edges, among the edges, having the corresponding first parameter greater than a predetermined value are left in the first machine learning model;
generates second masks indicating that third edges, among the edges, included in the upper predetermined percentage in descending order of the corresponding second parameter or fourth edges, among the edges, having the corresponding second parameter greater than the predetermined value are left in the second machine learning model.

11. The information processing device according to claim 10, wherein the processor:
selects one or more masks from the first masks and the second masks;
applies each of the one or more masks on a portion of the machine learning model corresponding to a union of the one or more masks; and
generates a third machine learning model that classifies classes corresponding to the one or more masks.

12. The information processing device according to claim 11, wherein the processor:
inputs data whose class to be classified is unknown to the third machine learning model; and
classifies the data into classes corresponding to the one or more masks.

13. A machine learning method comprising:
generating a first parameter relating to a first pruning process that generates a first machine learning model to classify a first class in a plurality of classes by executing the first pruning process on a machine learning model which classifies into the plurality of classes based on a parameter of the machine learning model and training data including the first class which serves a correct answer label; and
generating a second parameter relating to a second pruning process that generates a second machine learning model to classify a second class in the plurality of classes by executing the second pruning process on the machine learning model based on the parameter of the machine learning model, training data including the second class which serves the correct answer label and a loss function including the first parameter relating to the first pruning process.

14. The machine learning method according to claim 13, wherein the generating the second parameter includes:
minimizing the loss function including a first term which represents a difference between a classification result of the second class by the second machine learning model and the correct answer label, and a second term which represents a difference between the first parameter and the second parameter.

15. The machine learning method according to claim 13, wherein
the machine learning model is a neural network, and
the first parameter corresponds to each of edges included in the machine learning model and is a score which increases as a first degree of appropriateness to be left as an edge of the first machine learning model for the respective edges becomes higher, and
the second parameter corresponds to each of the edges included in the machine learning model and is a score which increases as a second degree of appropriateness to be left as an edge of the second machine learning model for the respective edges becomes higher.

16. The machine learning method according to claim 13, wherein the processing further comprising:
generating first masks indicating that first edges, among the edges, included in an upper predetermined percentage in descending order of the corresponding first parameter or second edges, among the edges, having the corresponding first parameter greater than a predetermined value are left in the first machine learning model;
generating second masks indicating that third edges, among the edges, included in the upper predetermined percentage in descending order of the corresponding second parameter or fourth edges, among the edges, having the corresponding second parameter greater than the predetermined value are left in the second machine learning model.

17. The machine learning method according to claim 16, wherein the processing further comprising:
selecting one or more masks from the first masks and the second masks;
applying each of the one or more masks on a portion of the machine learning model corresponding to a union of the one or more masks; and
generating a third machine learning model that classifies classes corresponding to the one or more masks.

18. The machine learning method according to claim 17, wherein the processing further comprising:
inputting data whose class to be classified is unknown to the third machine learning model; and
classifying the data into classes corresponding to the one or more masks.
